(19) United States
(12) Patent Application Publication
(10) Pub. No.: US 2009/0033978 A1
(43) Pub. Date: Feb. 5, 2009

(54) METHOD AND SYSTEM FOR AGGREGATING PRINT JOBS

(75) Inventor: Javier A Morales, Irondequoit, NY (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: XEROX CORPORATION, Stamford, CT (US)

(21) Appl. No.: 11/830,980

(22) Filed: Jul. 31, 2007

(51) Int. Cl. G06F 3/12

(52) U.S. Cl. 358/1.15

(57) ABSTRACT

A computer implemented method of automatically aggregating multiple print jobs is provided. The method includes storing a first print job set comprising a plurality of first type print jobs in memory in which each one of the first type print jobs comply with print job aggregation criteria. If a first selected condition is met, the first type print jobs of the first print job set are aggregated. Second type print jobs failing to comply with the print job aggregation criteria are stored as a second print job set. If a second selected condition is met, a determination as to whether the second type print jobs of the second print job set are aggregatable is made. Responsive to such determination, the second type print jobs of the second print job set may be either aggregated or processed without aggregation.

### CROSS-REFERENCE TO RELATED APPLICATIONS

Cross-reference is made to U.S. patent application Ser. No. ______ (Attorney Docket No. 20061267-US-NP) that was filed on the same day as the present application by the same assignee with the same title, and to U.S. patent Ser. No. ______ (Attorney Docket No. 20070201-US-NP) that was filed on the same day as the present application by the same assignee with the same title.

### BACKGROUND AND SUMMARY

The disclosed embodiments relate generally to a system and method for aggregating print jobs, if possible, and, more particularly, to an approach for handling deviations in ideally defined production-mandated aggregation

Creation and production of printed documents often involves many production and finishing operations that are highly variable with each job. In general, the various operations can be grouped into three major phases: 1) creation of the document information, including prepress operations that render the document in a form suitable for printing, 2) printing of the information onto some form of media such as paper, and 3) finishing of the selected media into a completed document. These 3 major phases often have many sub-phases, and the entire process may vary from relatively simple to extremely complex.

U.S. Pat. No. 6,462,756 B1 to Hansen et al. discloses a system and method for managing production printing workflow. The system includes workflow management software for managing and facilitating the procedural stages of the workflow including job origination, job preparation, job submission and job fulfillment. The workflow management software provides an integrated object oriented interface which visually reflects and interacts with the workflow. The software further provides functionality for efficient page level modifications to documents at the job preparation stage. This functionality allows such modifications to be easily made to selected pages and visually verified by displaying visual representations of the modifications on visual representations of the pages.

U.S. Pat. No. 7,092,963 B2 to Ryan et al. discloses a print production and finishing system for electronic management and control of a wide range of finishing processes characterized by input from multiple production operations and equipment that, depending upon the job, might be variably applied to work pieces that themselves are highly variable between different jobs. The disclosed embodiments of the '963 patent are applicable to many operations where processes for production of work pieces are managed separately from processes for finishing and packaging of such work pieces.

At least three related references, namely U.S. Pat. Nos. 6,650,433; 7,133,149; and 7,187,465 are concerned with aggregating print jobs. In one disclosed approach, jobs may be aggregated as follows:
The prepress aggregation module, a rules-based program, aggregates print jobs by scanning the Ordered Items table of the central database and searching for items (print jobs) that have the same printing requirements, e.g., the same delivery date, paper grade, and post press processing requirements. Scanning generally continues until enough print jobs have been located to fill a layout of a given size. The XML files corresponding to the selected print jobs are then pulled from the Document Table, converted to PostScript files and aggregated, as discussed above.

In large print shop settings it is sometimes desirable to “gang” or “aggregate” jobs so that a high speed digital press, such as a production based continuous feed printer can achieve relatively long print runs. Print job aggregation can be reasonably straightforward provided related print jobs meeting the same aggregation criteria (e.g., having the same media size) can be grouped together. For those instances, however, where incoming jobs are difficult to group, possibly due to disparate attributes (e.g., disparate print quantities), it may be difficult to achieve this sort of optimal grouping. Moreover, in other instances it might be possible to group jobs in accordance with common aggregation criteria, but, because the jobs are unrelated (possibly originating from disparate sources) it might not be feasible to aggregate the jobs as originally planned (possibly in a multiple-up format where each cut stack corresponds with a single user). Improved print job aggregation techniques for unrelated jobs are warranted.

The pertinent portions of all of the above-mentioned patents are hereby incorporated by reference.

In accordance with a first aspect of the disclosed embodiments there is disclosed a computer implemented method of automatically aggregating multiple print jobs, comprising: (A) receiving a print job; (B) determining, with a system manager, whether the received print job complies with print job aggregation criteria; (C) if the received print job complies with the print job aggregation criteria, associating the received print job with one or more print jobs of a first print job set, each one of the one or more print jobs of the first print job set complying with the print job aggregation criteria; (D) if a first selected condition is met, (1) aggregating the print jobs of the first print job set, and (2) causing the aggregated first print job set to be processed with at least one document processing resource; (E) if the received print job does not comply with the print job aggregation criteria, associating the received print job with one or more print jobs of a second print job set; and (F) if a second selected condition is met, (1) determining if the print jobs of the second print job set are aggregatable, and (2) responsive to (F)(1), either (a) aggregating the print jobs of the second print job set and causing the aggregated second print job set to be processed with at least one document processing resource, or (b) causing a non-aggregated second print job set to be processed with at least one document processing resource.

In accordance with a second aspect of the disclosed embodiments there is disclosed a computer implemented method of automatically aggregating multiple print jobs, comprising: (A) storing a plurality of print jobs in memory, each one of the plurality of print jobs complying with a selected print job aggregation criteria; (B) aggregating the plurality of print jobs stored in memory in a first print job aggregation mode if a selected condition is met within a selected time interval; (C) if the selected condition cannot be met within the selected time interval, determining whether the plurality of print jobs can be aggregated in accordance with a second print job aggregation mode; (D) responsive to said (C) either, (1) aggregating the plurality of jobs in accordance with the second print job aggregation mode and causing the plurality of jobs aggregated in accordance with the second print job aggregation mode to be processed with at least one document processing resource, or (2) causing the plurality of print jobs, in an non-aggregated form, to be processed with at least one document processing resource.

In accordance with a third aspect of the disclosed embodiments there is disclosed a computer implemented method of automatically aggregating multiple print jobs, comprising: (A) storing a first print job set comprising a plurality of first type print jobs in memory, each one of the first type print jobs complying with print job aggregation criteria; (B) if a first selected condition is met, (1) aggregating the first type print jobs of the first print job set, and (2) causing the aggregated first print job set to be processed with at least one document processing resource; (C) storing a second print job set comprising a plurality of second type print jobs in memory, each one of the second type print jobs failing to comply with the print job aggregation criteria; and (D) if a second selected condition is met, (1) determining if the second type print jobs of the second print job set are aggregatable, and (2) responsive to (D)(1), either (a) aggregating the second type print jobs of the second print job set and causing the aggregated second print job set to be processed with at least one document processing resource, or (b) causing a non-aggregated second print job set to be processed with at least one document processing resource.

In accordance with a fourth aspect of the disclosed embodiments there is disclosed a system for automatically aggregating multiple print jobs, comprising: a system manager for controlling a flow of print jobs in the system; and a computer-readable storage medium comprising one or more programming instructions that, when executed, instruct the system manager to: determine whether a received print job complies with print job aggregation criteria, if the received print job complies with the print job aggregation criteria, associate the received print job with one or more other print jobs complying with the print job aggregation criteria, the one or more print jobs complying with the print job criteria comprising a first print job set, if a first selected condition is met, (1) aggregate the print jobs of the first print job set, and (2) cause the aggregated first print job set to be processed with at least one document processing resource, if the received print job does not comply with the print job aggregation criteria, associating the received print job with one or more print jobs of a second print job set, if a second selected condition is met, (1) determine if the print jobs of the second print job set are aggregatable, and (2) responsive to determining if the print jobs of the second print job set are aggregatable either (a) aggregate the print jobs of the second print job set and cause the aggregated second print job set to be processed with at least one document processing resource, or (b) cause a non-aggregated second print job set to be processed with at least one document processing resource.

### BRIEF DESCRIPTION OF THE DRAWINGS

FIG. 1 is a block diagram of a document processing workflow including a production monitor controller (PMC), the workflow being suitably configured for use with the disclosed embodiments;

FIG. 2 is a block diagram emphasizing selected aspects of the workflow of FIG. 1, including the PMC with various inputs and outputs, such as a virtual job ticket database (VJTDB);

FIG. 3 is a planar view of a job segment identifier sheet;

FIG. 4 is a flowchart illustrating a computer implemented approach for aggregating print jobs;

FIG. 5 is a schematic diagram illustrating how three jobs might be combined over time;

FIG. 6 is a block diagram of a print job aggregation workflow employing some of the components of FIGS. 1 and 2;

FIG. 7 is a planar view of an aggregation job ticket intended for employment with the print job aggregation workflow of FIG. 6;

FIG. 8 is a flowchart illustrating another computer-implemented approach for aggregating print jobs;

FIG. 9 is a flowchart illustrating yet another computer-implemented approach for aggregating print jobs;

FIG. 10A is a top planar view of a print media stack in which two different document types have been imposed across the stack;

FIG. 10B is a top planar view of a print media stack in which three different document types have been imposed across the stack;

FIG. 10C is a perspective view of a print media stack where multiple documents have been imposed in such a way that a vertical cut in the stack permits the multiple documents to be stacked in a collated manner;

FIG. 11 illustrates a block diagram of a system that can use ganging criteria to combine print jobs into a single imposition and use that imposition to produce printed product;

FIG. 12 is a flowchart illustrating an approach for producing an aggregated or ganged job;

FIG. 13 is a schematic view illustrating a set of ganged criteria;

FIG. 14 is flowchart illustrating an approach for using quantity ratios to produce an imposition;

FIG. 15 is a schematic view illustrating a rounding process in accordance with aspects of certain embodiments; and

FIG. 16 is a flowchart illustrating an alternative process to be used in conjunction with the process of flowchart of FIG. 9.

### DESCRIPTION OF DISCLOSED EMBODIMENTS

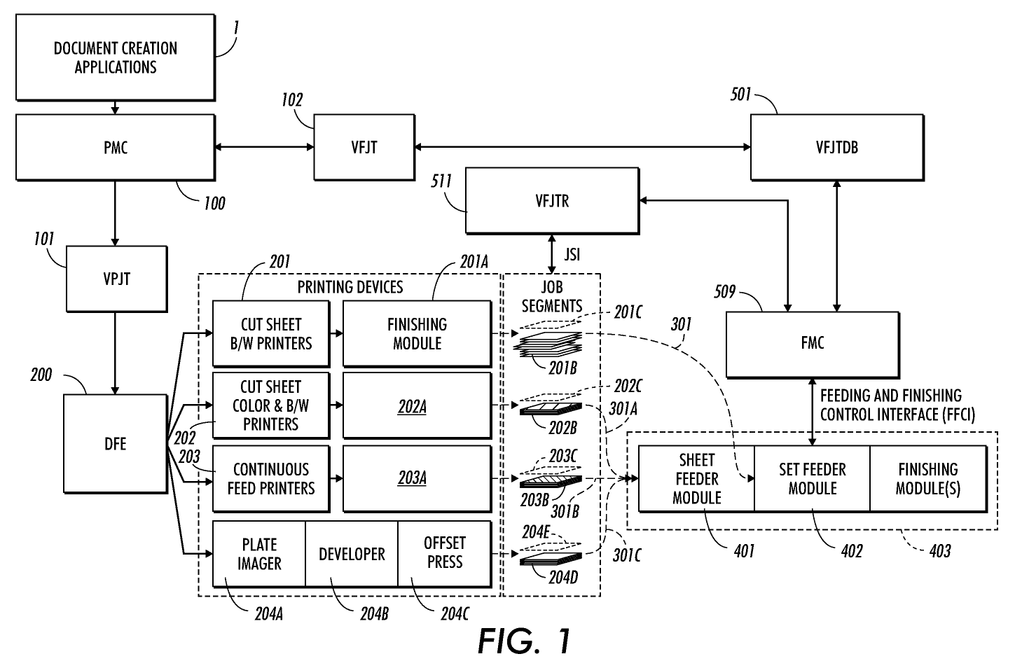

Turning now to FIG. 1, an overview of a workflow suitable for use with disclosed embodiments is shown. Within FIG. 1, box 1 represents prepress operations, and the output of the prepress operations of box 1 is a set of appropriate PDL files that are delivered to a Production Monitor Controller (PMC), 100. As described more fully below, the PMC is a controller that coordinates overall production of the print job.

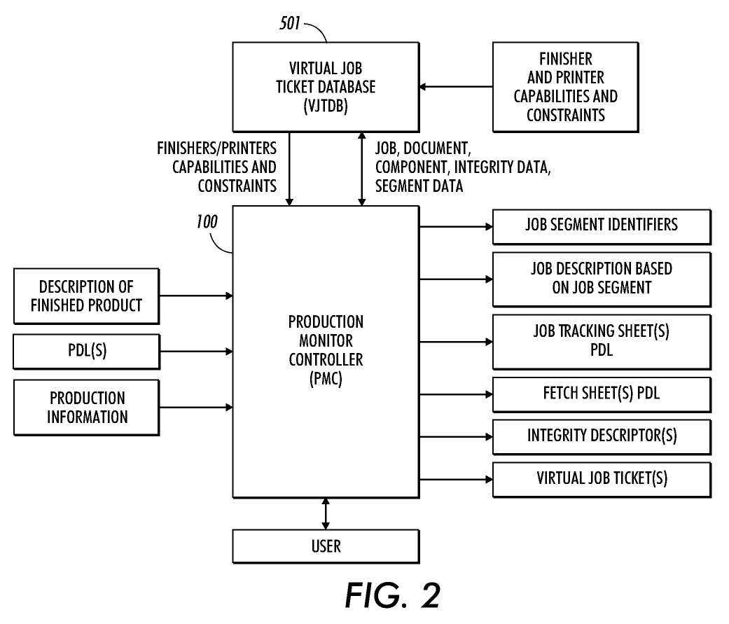

FIG. 2 shows some exemplary inputs and outputs of the PMC 100, as well as the relationship between the PMC and a virtual finishing job ticket database (VFJTDB) 501. In general, the inputs to the PMC 100 include some or all of: 1) from the Virtual Printer Job Ticket Database (“VPJTDB”), a list of printer capabilities and constraints; 2) from the VFJTDB, a list of assembler/finisher capabilities and constraints; 3) a description of the finished product which may be a CIP3 or similar description; 4) PDLs and other files for the content of each sheet to be printed; 5) production information such as the number of copies, targeted printing devices, and any special finishing or packaging attributes, including, without limitation, the identity and retrieval location of any non-printed and/or inventory items. In general, the output from the PMC includes identification of each job segment for each operation within the job as well as a set printing and assembling/finishing instructions for each job segment. More specifically, the output from a PMC comprises some or all of: 1) a job segment description and identifier(s) for each job segment; 2) a database representation (such as the VJTDB description explained below) of the structure of the job segments and the document components, sheets or sets within the job segment; 3) a PDL file for a job tracking sheet, if any; 4) a PDL for a fetch sheet, if any; 5) integrity descriptors encoded into the VFJTDB for later use by a Finishing Module Coordinator (FMC); 6) virtual job tickets for printers and Assembler/finishers; and 7) a prompt to call for one or more human operator responses.

Referring again to FIG. 1, the instruction set for printing and assembling/finishing is output from PMC 100 in the form of both a Virtual Print Job Ticket (VPJT), 101, and a Virtual Finishing Job Ticket (VFJT), 102. The VFJT and VPJT may contain the complete instruction set for the job or may simply contain reference pointers to a database where such information is retained. The VPJT 101 is conventional in the art as discussed in relation to U.S. Pat. Nos. 5,995,721 to Rourke et al., 5,615,015 to Krist et al., and 5,760,775 issued to Sklot.

The data for each VFJT is recorded by the PMC in the VFJTDB shown in FIG. 1 as 501. In one example, the VFJTDB is a database or a data file that contains all job construction, control and integrity data necessary to take the prints coming from the printing device(s) and perform the necessary finishing processes to turn the prints into the desired final output form. The format of the VFJTDB can be hard copy (print), soft copy (floppy, CD-R, CR-RW) or electronic (electronically stored in memory or on a hard disk drive) copy form. The format may be one or both of human and machine-readable.

The type of data and instructions required in a VFJTDB 501 for each job are information such as but not limited to: accounting and administration information, sheet, set and job level finishing instructions, color and print quality control data, registration data, etc. The data and instructions also contain a description of the job segments (stacks and stacks of sets) of the job being produced and instructions on how to reassemble these pieces to complete the processing of the job. Additionally this information can enable the automatic setup of the finishing device(s), integrity control and monitoring throughout the full scope of the production processes. The VFTDB provides the basis for a direct link between the offline finishing operations and the integrity control functions of online printing and intermediate finishing systems. The VFJTDB data can take on the form of a proprietary format or an industry standard format such as but not limited to a modified form of CIP3.

Referring still to FIG. 1, the printing process may be commenced after delivery of the VPJT, 101, to one or more Digital Front End Print Controllers (DFE) represented by box 200. Such DFE's are conventional in the art. Examples include PDL products made by Splash, Harlequin, Adobe, and others. In conformance with instructions provided in the VPJT, 101, the print job is divided into separate printing job segments and is distributed to various print engines for printing using the printer or press which the operator or PMC, 100, believed to be optimal when the VPJT was first established. Alternatively, the VPJT may provide that the DFE, 200, sometimes through interaction with the PMC, 100, may automatically select the appropriate printing device based upon dynamic queue and print selection criteria.

Boxes 201-204 of FIG. 1 are examples of various types of printers to which document components may be delivered for printing. Printer 201 may be a cut sheet digital printer connected to an integrated finishing module 201A. Integration between printer 201 and finisher module 201A is accomplished using DFA or MFFA-type protocols. As discussed above, a typical finisher module 201A includes capabilities such as collation, folding, and simple binding such as stapling. Printer 202 may be a cut sheet printer with a combination of color and monochrome printing capability. The Document Centre® Color Series 50 printer sold by Xerox Corporation is such a printer. Finisher module 202A is integrated with printer 202 as shown in FIG. 1 and may have capabilities similar to those described in connection with finisher 201A. Similarly, printer 203 is shown as a continuous form feed printer and is integrated with finisher module 203A. Printer 204 represents the various apparatus and processes normally associated with offset printing, including the prepress steps of preparing offset plates at a plate imager 204A, plate developer processor 204B, and offset printing press 204C. Unlike printers 201-203, which may be digitally integrated with their respective intermediate finishing modules 201A-203A, offset presses are not digital imaging devices and lack direct digital integration with assembly and finishing equipment.

As shown in FIG. 1, each of finishing modules 201A-203A and offset press 204C place their respective job segments in their respective output trays or bins 201B-203B and 204D. When placed in such trays or bins, the job segments or may not be collated, stacked or otherwise separated for handling and conveyance. Also each of finishing modules 201A-203A may provide some intermediate level of finishing, such as folding or stapling. Multiple document components may be printed or assembled at the same printer and intermediate finishing station and be treated during this phase of the job as one job segment. Conversely, a single large document component may be output in a stack with separator sheets or offset stacks indicating multiple job segments within the single document component.

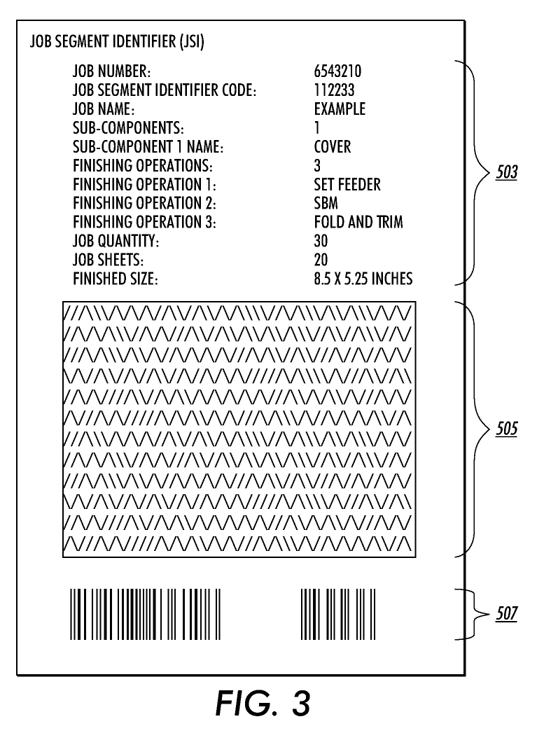

Referring to FIGS. 1 and 3, another aspect of the disclosed embodiments is the association of a unique Job Segment Identifier (JSI) with each job segment. In FIG. 1, a sheet containing a JSI is shown in association with each job segment that is output from printers 201-204. The respective JSI sheets are labeled 201C-203C and 204E, respectively. For complex jobs or for document components that are printed in large stacks, there may be many JSIs corresponding to many job segments within the job or within the stacks.

A JSI can assume any form that can be associated with a job segment throughout the finishing and other applicable printing processes. Among such forms are copies stored in (a) a printed sheet printed and placed on top of a printed job segment, (b) system memory such as hard drives, (c) magnetic media such as floppy disks or magnetic strips, (d) optical memory such as CD-ROM or CR-RW disks, (e) bar code symbols printed on sheets associated with the Job Segment, or (f) any other means by which machine or human readable identifying information may be associated with a Job Segment. A JSI may be machine, human readable, or both depending upon the phase of the job. Indeed, in the event that a scanner is capable of reading the top printed page of a job segment in such manner that the job segment can be uniquely identified, then no special symbols or special top page would be necessary. Thus, each JSI contains, as a minimum, a job and job segment number or other identifier that uniquely identifies the job segment from all other job segments. Typically, the JSI comprises both a unique job number and a Job Segment Identifier Code (JSIC). The job number uniquely identifies the print job from all other print jobs and the JSIC uniquely identifies the job segment. In one embodiment, the JSIC comprises recognizable unique text on the top sheet of a job segment, which JSIC forms a vector to a JSI that remains encoded in digital memory. Whichever form a JSI takes, the JSI serves as a reference pointer to the portion of the VFJTDB that describes the contents of the identified job segment. The JSI remains associated with the applicable job segment when it is transported from the printing device(s) to other finishing processes. This enables tracking of the job segment from the printing device(s) to the assembler/finisher apparatus. Whether or not the job segments are part of a job that requires prints to be produced on one or more printing device(s), each JSI will have a common job number but a different JSIC that uniquely identifies each particular job segment of the job.

In FIG. 1, the JSIs are shown in the form of a printed sheet called a Job Segment Identifier Sheet (JSIS) that is typically printed along with the sheets of the job and is placed on top of the job segment stack in the output trays or bins, 201B-203B and 204D. Such JSIS sheets are shown in FIG. 1 as 201C-203C and 204E. Information on a JSIS comprises either (a) a pointer (the job number and JSIC) to VFJTDB stored in some other electronic or soft copy format or (b) the portion of the VFJTDB itself that provides instructions for the job. Such instructions may be printed on the JSIS in electronic or human readable form. In contrast to conventional separator sheets that are placed upon each stack of printed output no matter how large the stack, each JSI serves as a unique identifier of each job segment of a print job.

Referring to FIG. 3, an example of a JSIS is shown. Human readable text comprising the JSI and job instructions is shown at region 503. In region 505, machine readable glyphs are shown containing the full data content of the VFJTDB applicable to the identified job segment. In region 507, a machine readable bar code is shown which comprises a pointer to the VFJTDB stored elsewhere.

In the final assembly and finishing phase, the various document components are gathered from output trays or bins 201B-203B and 204D, assembled in a particular order, and finished into a specified document form. In FIG. 1. arrows 301 and 302A, B, and C show the conveyance of printed job segments from output trays or bins 201B-203B and 204D to finishing Set Feeder Module 402 and Sheet Feeder Module 401, respectively.

As contemplated by the disclosed embodiments, each job segment arrives at the assembler/finisher apparatus with a JSI reference pointer. As noted above, this typically will appear on a JSIS although any form of JSI will suffice. The purpose of the JSI is to identify a particular job segment to a Finishing Module Coordinator (FMC) 509, which is a controller suitable for directing the assembler/finisher operations. In FIG. 1, a Virtual Finishing Job Ticket Reader (VFJTR) is shown as 511 and is responsible for reading the JSIS or for otherwise providing information to the FMC, 509, sufficient for the FMC to determine the unique JSIC. Humans may also intervene in the process to submit JSICs to the FMC, particularly if a JSIS is only human readable. The FMC, 509, is a software-based controller that manages, interprets, sequences, and allocates assembler/finisher production data. Using a variety of interfaces to each assembler/finisher device, the FMC communicates to each device the data required to program that device for implementation of the job. It tracks each job segment through the process and ensures that job segments are properly loaded before the devices begin operating.

The FMC also typically provides information to human operators concerning job status and in order to enable operators to make production decisions where necessary or appropriate. The FMC operates by receiving the JSI that identifies each job segment and determining whether the JSI itself contains all required assembler/finisher data. If a JSIS or similar JSI does not provide all instructions for finishing the job, then the FMC uses the JSIC to retrieve all relevant information concerning the job model stored in the VFJTDB. The FMC then reviews the assembler/finisher combinations prepared by the PMC to ensure that all identified devices are currently available. Once this condition is satisfied, then the FMC determines the bins or other assembler/finishing locations where each job segment should be placed. In general, the FMC communicates with the PMC through the VFJTDB. Where assembler/finisher devices are automatically programmable, the FMC may be programmed to interact with the specified interface format for each device in order to automatically provide programming instructions. Job tracking and integrity information would also be provided. When all required job segments have been loaded in their appropriate bins, the FMC would either direct the assembler/finisher devices to begin or would inform human operators that the job is ready. In this manner, the complete assembler/finisher operation can be controlled, implemented, tracked, and checked for integrity.

Further detailed description regarding structure and operation associated with FIGS. 1-3 is provided in U.S. Pat. No. 7,092,963 B2 to Ryan et al., the pertinent portions of which are incorporated herein by reference.

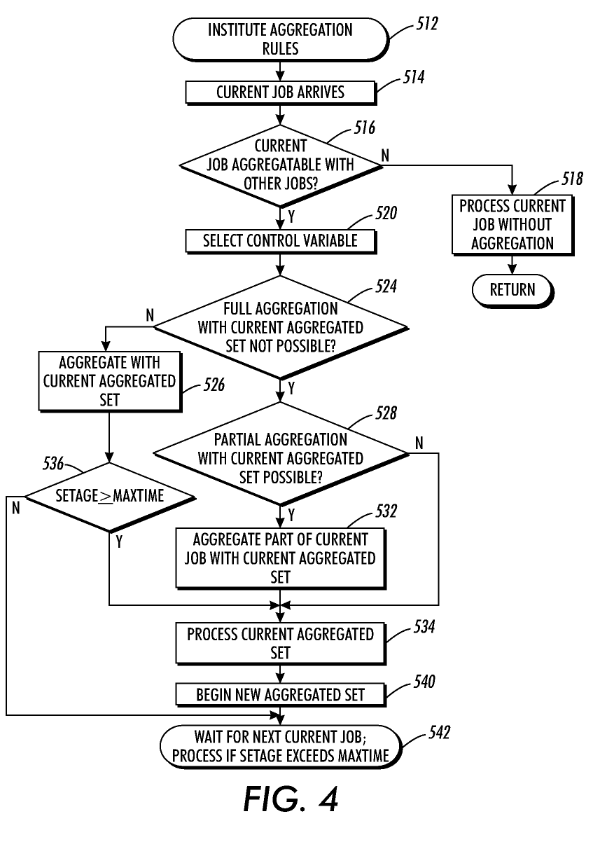

Referring to FIG. 4, an exemplary computer implemented approach for both generating and managing an aggregated print job set or print job group is described. Initially, at 512, a set of aggregation rules is provided. While letter size, may be used as one criteria for aggregation, there are many criteria that will appear to those skilled in the art, including media type (size, weight, or color), printing system color, gloss, grain, opacity, desired image quality, just to name a few. As each job arrives (514), the current job may be assessed (516) to determine if it is aggregatable (i.e., beneficially combinable) with other stored jobs. Each non-aggregatable job is processed in a normal course (518), while, at 520, a control variable for aggregation is selected. One control variable might include job size, As can be appreciated by those skilled in the art, “job size” can be defined in several contexts. For instance, job size could refer to a “quantity of sets,” or “a first quantity of pages per set multiplied by a second quantity of sets,” just to name a few. Other control variables, such as job age, are contemplated by the disclosed embodiments. A plurality of control variables may be applied.

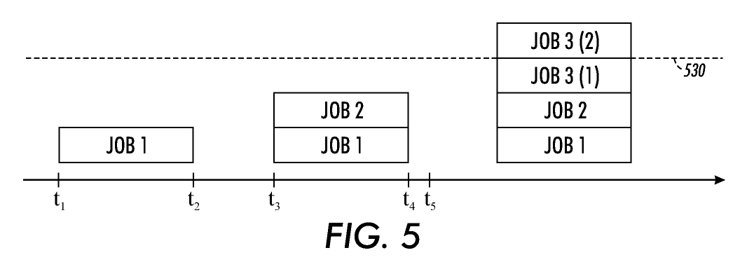

At 524, a determination as to whether all of the current job can be aggregated with a combination of stored jobs is made. If the entire current job is aggregatable, then the aggregation of 526 is performed; otherwise, at 528, a second level determination, regarding partial aggregation, is made. Referring briefly to FIG. 5, a concept of full or partial aggregation is described. As shown, Job 2 can be completely aggregated with Job 1 because a combination of the two jobs does not exceed a given threshold 530. In a first example, the threshold 530 corresponds with an output constraint, such as the page capacity or size of an output device (such as an output stacker or finishing device). As can be appreciated by those skilled in the art, output constraints can correspond to physical constraints or characteristics of the hardware devices used in production or they may correspond to less tangible concepts such as shop policies. For instance, the threshold 530 could be varied to reflect a job or container limit. Additionally, each of Job 1 and Job 2 can be placed in n-up format so that the number of printable pages for each job can be reduced considerably. In one approach, letter size pages are imposed electronically on 11×17 media, and, pursuant to finishing, cut and stack operations can be performed to return the aggregate job to its original intended components.

In one example, Job 3 (a combination of Job 3(1) and Job 3(2)) cannot be completely aggregated with the current aggregate job (including Jobs 1 and 2) because the combination of Jobs 1, 2 and 3 exceed the threshold 530. In this event, Job 3 can either be excluded from the current aggregate job, and the current aggregate job processed by the system, or a part of Job 3 (Job 3(1) in the example of FIG. 5) can be aggregated with the current aggregate job or set (532 of FIG. 4) and a current aggregated set of Job 1, Job 2 and Job 3(1) can be processed (534). It should be appreciated that Job 3 is most easily divided along set boundaries (if they exist) and that, in the absence of a convenient boundary along which to divide Job 3, it might be undesirable to aggregate even part of Job 3 with Jobs 1 and 2. In the event that aggregation of partial Job 3 is undesirable, Jobs 1 and 2 are simply processed without any of Job 3.

As contemplated, permitting a given aggregate job to exceed a select age is undesirable. Consequently, referring to FIG. 4, when a maximum storage age (“Maxtime”) of an aggregate job or set exceeds the storage age (“Setage”) of the aggregated set (536), then the current aggregate job is processed (via 534). Referring again to FIG. 5, the exemplary approach of processing an aggregate job on the basis of age can be further understood. In particular, after aggregating the jobs at t₄, a check (536 of FIG. 4) may be performed at t₅. Assuming t₅ is greater than Maxtime, then the aggregate of Jobs 1 and 2 is processed via 534.

Referring now to FIGS. 4 and 5, for the example in which Job 3(1) is combined with Jobs 1 and 2, a new aggregation set (including Job 3(2)) is begun at 540. Then the system waits (542) for the next job to determine, by way of 516, whether it can be aggregated with Job 3(2). Referring still to 542, for those instances in which aggregate jobs are not permitted to age past a given Maxtime, the check of 536 is performed periodically for the current aggregate set.

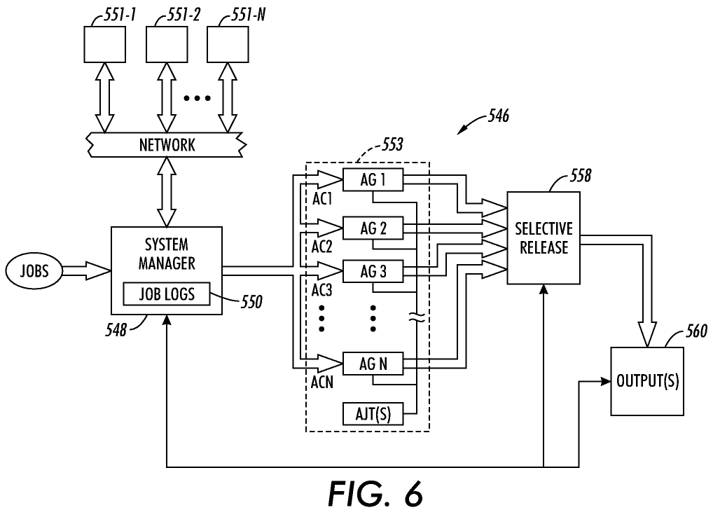

Referring now to FIG. 6, a print job aggregation workflow 546, employing some of the components of FIGS. 1 and 2, is shown. With the print job aggregation workflow of FIG. 6, print jobs can be sorted into proposed aggregation groups, and then tracked along the workflow. As shown in the example of FIG. 6, jobs are received at a system manager 548. As contemplated, the system 548 may comprise any suitable computing platform including appropriate amounts of memory and processing capability. In one example, the system manager includes a memory section, designated by the numeral 550 and labeled “Jobs Log,” for maintaining tracking information about jobs handled by the print job aggregation workflow. Additionally, the system manager communicates with several clients 551-1 through 551-N by way of a suitable local or wide area network (which may include, at least in part, the world wide web) 552. A communication network suitable for use with the workflow 546 is disclosed in U.S. Pat. No. 5,220,674 to Morgan et al., the pertinent portions of which are incorporated by reference. As can be appreciated by those skilled in the art, network clients could be apprised of the processing status of jobs via conventional print protocols, as well as through general purpose web protocols.

Finally, the system manager 548 communicates with a memory section 553 for storing one or more print job aggregation groups (AG 1, AG 2, AG 3, . . . , AG N), as well as one or more aggregation job tickets (AJT(s)). It should be appreciated that each of the each one of the aggregation groups corresponds with one or more print jobs and that each of the one or more print jobs may correspond with a single aggregation criteria (AC). AC might be based on one of several criteria that would appear to those skilled in the art, including media type (size, weight, or color), bindery or finishing intent, printing system color, gloss, grain, opacity, desired image quality, just to name a few. While the aggregation groups are shown as discrete entities, discrete separation of the groups is unnecessary. For instance, all of the print jobs in memory section 553 could be stored in the order in which they were received and separation could be achieved virtually with each print job having a pointer to a given AC.

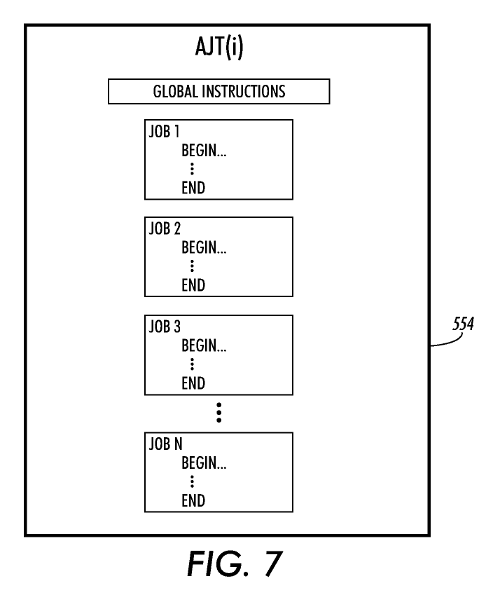

The exemplary workflow of FIG. 6 takes advantage of one or more AJTs to facilitate flow of the jobs through the system. As contemplated, an AJT could be provided for each AG, or the AJTs for all of the AGs could be combined into one. Referring to FIG. 7, an exemplary AJT for a single AG (AJT(i) 554) is shown. In the example of FIG. 7, a set of global instructions (relating, for example, to media characteristics, print quantity and set-up requirements) is used to control the instruction sets for N print jobs. As shown, each print job instruction set is discreet, with appropriate beginning and end instructions. Further information regarding job tickets is provided in U.S. patent No. to Bonk et al, the pertinent portions of which are incorporated herein by reference.

Referring again to FIG. 6, a selective release 558, controlled by the system manager, permits a given AG to be sent to one or more outputs 560 when a selected release condition is met. In practice, the selective release includes a list of release conditions. For instance, an AG might be released when either its page count or print quantity reach a selected threshold. Other release conditions, such as AG age, are contemplated by the disclosed embodiments. In one example, the selective release comprises one or more instructions which operative in conjunction with the system manager 548 for causing one of the AGs to be transmitted to the outputs 560.

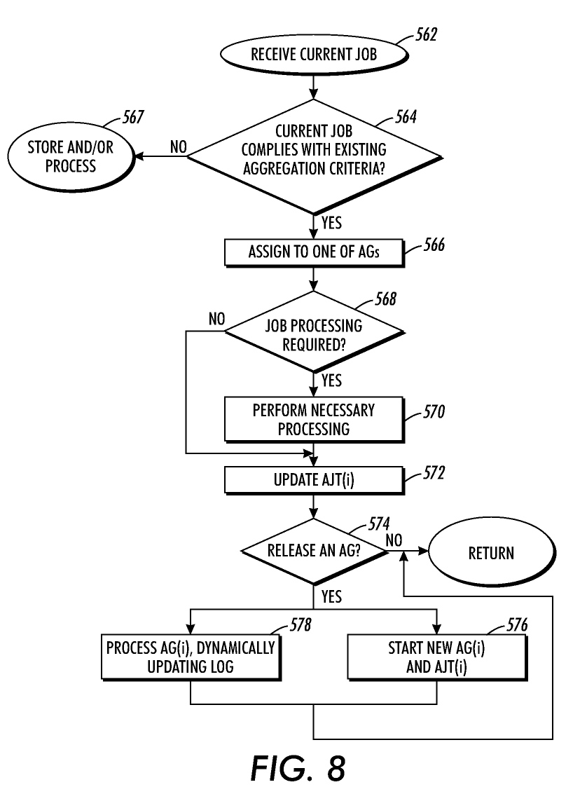

The operability of the print job aggregation workflow 546 can be more fully comprehended by reference to the flowchart of FIG. 8 and the following discussion

(1) The workflow examines each incoming print job (562), and each print job complying with a predefined AC (positive answer at 564) is assigned to one of multiple AGs (566). For example, JDF jobs may be sorted by media, media size, and binding intent. The AC may be associated with the cost required to change a production setup requirement (i.e., a setup requirement associated with either a print job or print related device) to produce a different output, e.g., for continuous feed printers, loading a new media (new paper web) is costly because of lost machine productivity during the changeover as well as the labor cost to thread the new media. Other setup requirements might include providing forms and/or inserts for use in processing a job, as well as a setup adjustment for a finishing/binding related resource. In one approach, jobs that do not meet an AC may be, via 567, stored in a selected AG for later processing, or processed as soon as possible.

(2) Once AGs have been defined and jobs start collecting, the system will evaluate configuration rules to determine how jobs should be aggregated and when might require further processing. Depending on the shop defined aggregation criteria, the system may have multiple levels of aggregation files.
Referring to 568 and 570 of FIG. 8, the workflow might have general aggregation processing rules for use with jobs to be assigned to the AGs. For instance, when printing a series of contiguous duplex jobs, each one of certain new duplex jobs should begin on an odd (recto) output page in order to prevent printing of the first page of one job on the back page of another job.
Referring still to 568 and 570, the workflow 546 might have aggregation rules that are applied on an AG by AG basis. For example, the system might add blank pages (pad) jobs in only one AG to ensure that each imposed layout only contains a single job. In particular, if the imposition layout used four pages per sheet, the workflow might add pages to ensure that the page count is a multiple of four. This rule would apply to, for example, aggregated booklets.

(3) The workflow might also aggregate jobs for packaging/management purposes. For instance, the workflow might aggregate PDF jobs into a variable information container to allow efficient placement of PDL jobs that share common resources. This could be useful to, for example, mimic “Come and Go imposition” in automated prepress systems that do not support sophisticated imposition.

(4) As mentioned above, the workflow might create an AJT (572) whose main purpose would be to retain the discreet nature of all the jobs that are aggregated together. This ticket, in one approach, would be associated with an AG (572) and would be used as a holder for all the job ticket information on the aggregated jobs. It follows that a given AJT would be updated each time a given job is added to a corresponding AG. JDF tickets comprehend job parts and the concepts underlying the development and use of such JDF tickets could be used to represent the job ticket information of discrete jobs.

(5) The workflow 546 may be configured with criteria (574) for determining when aggregation should complete and production of one or more AGs should commence. This may be configured based on a number of criteria. Some envisioned examples include (a) number of aggregated jobs, (b) number of pages in aggregated document, (c) when a predefined marker is found on an input job, (d) when the oldest job in a given AG reaches a certain age.

Elaborating on (5), in one example, if the page count of a given AG exceeds the capacity of a given output device, the system will proceed to process all but the last job in the aggregation group. A part of the last job (possibly one or more job sets defined by set boundaries) may be processed with all but the last job. Referring to 576, the last job, or part of the last job, may then become the first job of the next aggregation set. Other potential variables for aggregation could include print quantity. This could be used in a couple of different ways. For instance, thresholds for aggregating could be set at less than n sets. Also, an incoming job could be aggregated with an existing AG and a determination could be made as to whether the job fits as a part of the existing AG or constitutes the start of a new AG. If the job does not fit the system might start a new AG but keep the old AG open for additional jobs. Jobs would then be fit into an AG by looking at the oldest AG(s) first and only looking at a further AG(s) if the job does not fit in the oldest AG. As contemplated by the disclosed embodiments, a given AG would only be stored for a selected time interval—after the selected time interval, the given aggregated AG would be transmitted to the output(s) 560 (FIG. 6) for processing. As is also contemplated by the disclosed embodiments, time values (such as the end of a second of two shifts) or setbacks from production relevant time events (such as a courier pickup time) can also be used to trigger the transmission of an aggregated AG to the output(s) 560.

(6) As production starts, the workflow may perform the defined prepress and press operations on the jobs of a given AG. Since the system keeps track of what portions of each AG belong to specific input jobs, the system will update job logs (e.g., JDF AuditPools) while hiding the fact, from typical system consumers, that the print jobs were aggregated.
The workflow 546 is capable of notifying upstream components as if the jobs were being processed independently, thus enabling accurate tracking of each job's progress to systems that are unaware of the production aggregation.
In the event the workflow needs to submit jobs to downstream components (e.g. JDF-enabled offline finishing devices), the system is capable of extracting information about specific jobs from the AJT, and submitting such information to an appropriate destination, thus enabling post-print disjointing of jobs. This would enable discreet jobs to be further processed without impairing the progress or status of the corresponding AG.

As described above, the system of FIG. 6 can gather jobs that meet specified criteria in preparation for the creation of a “production unit” (also referred to above as “aggregation set”). However, in addition to simply holding jobs for potential aggregation, the system can gather information related to predefined criteria for alternate, less efficient processing. Examples of information that the system may store about the jobs include:
Time at which the job was held—This might be useful, for example, if the age of the oldest job was used as criteria for selecting alternate production-mandated aggregation.
Due Date for the shop—This might be helpful, for example, if the system enforced a minimum time difference between a ship date and a print date of a job.
Production Plan for the job—In a more sophisticated version of the above, the system might have information about the planned schedule and the flexibility available in the planned schedule.

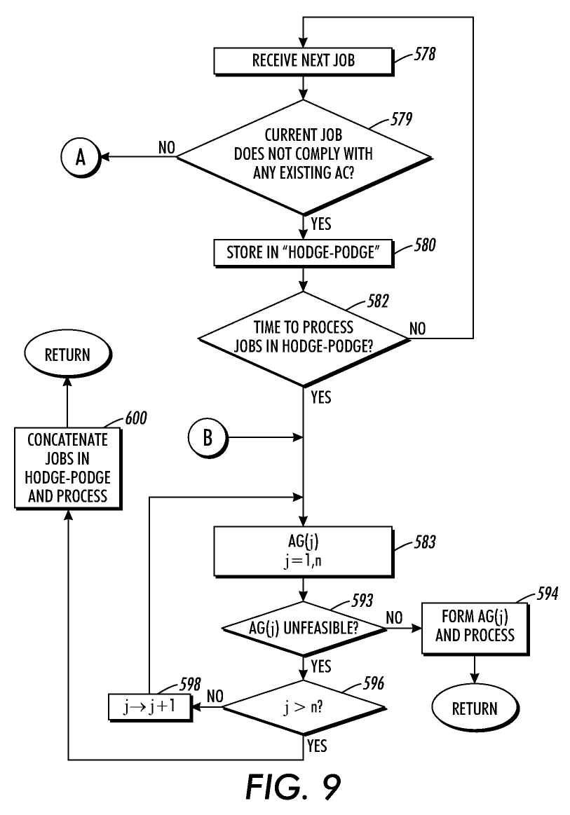

Referring now to FIG. 9, a process for handling jobs that do not comply with one of the present ACs is described. Referring conjunctively to FIGS. 8 and 9, should be recognized that the two flowcharts can be readily harmonized in that jobs diverted to 567 may be processed in accordance with the approach of FIG. 9. In particular, jobs received at 578 which are found to not comply with any existing AC (via 579) may be stored in an AG referred to as “Hodge-Podge.” Referring back to FIG. 6, one of the AGs could be selected as the Hodge-Podge and, in this event, no AC would be assigned to the AG serving as the Hodge-Podge.

All jobs failing to comply with an existing AC may be stored in the Hodge-Podge (580) until a positive response to 582 is received. When the time to process the Hodge Potch jobs has arrived, the following subroutine might be performed to determine if the Hodge-Potch jobs could at least be subjected to some sort of alternative aggregation routine: At 583, a function for the Hodge-Potch jobs, namely AG(j) is defined and a range of 1 to n aggregation possibilities is set. As should be appreciated, the aggregation possibilities may be arranged in a hierarchy so that certain possibilities (e.g., “cut and stack” imposition) might be given priority over other aggregation possibilities (e.g., “slit and merge” imposition). Initially, AG(1) (an alternative aggregation group complying with a first alternative aggregation criteria AC_{ALT1}) is set and the jobs in the Hodge-Podge are examined to determine if they can be aggregated in accordance with AC_{ALT1}.

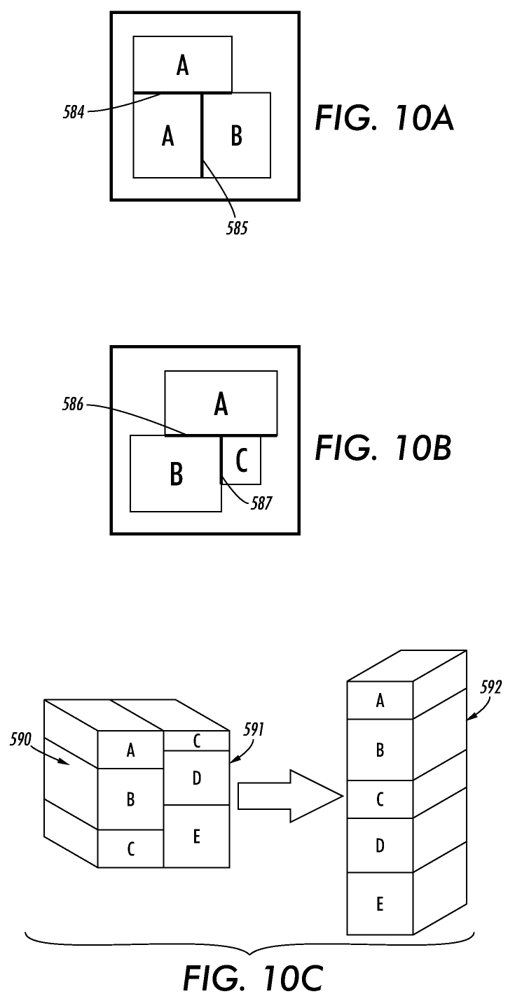

Some examples of alternative aggregation groups are provided in FIGS. 10A to 10C. FIG. 10A shows a top plane view of a 3-up aggregation arrangement in which, after cutting along cut planes 584 and 585, two stacks of a document A and one stack of a document B can be obtained. In the example of FIG. 10A each one of documents A and B have equivalent page dimensions. FIG. 10B is a multiple-up aggregation arrangement in which documents having varying page dimensions are imposed in such a way that, upon cutting along cut planes 586 and 587, three stacks of three differently dimensioned stacks may be obtained. The approaches associated with the examples of FIGS. 10A and 10B contemplate the imposition of varying numbers of documents (two, three or more) and the use of varying numbers of cut planes (two, three or more). FIG. 10C is a perspective view of another aggregation arrangement (formed with imposition) in which, subsequent to slitting the stack 590 along planes 591, the resulting stacks can be merged to form stack 592.

Referring back to FIG. 9, if an alternate aggregation is possible (negative answer to 593), then the process proceeds to 594 where the Hodge-Podge jobs are aggregated in accordance with the current alternative aggregation criteria. If aggregation is not possible (positive answer to 593) and j≦n (negative answer to 596), then j is incremented by one (598) and the possibility of forming another alternative aggregation group is considered. For the case in which each alternative aggregation has been considered and cannot be achieved with the jobs of the Hodge-Podge, the process proceeds to 600 where the jobs of the Hodge-Podge are simply concatenated and sent to one or more output devices for processing.

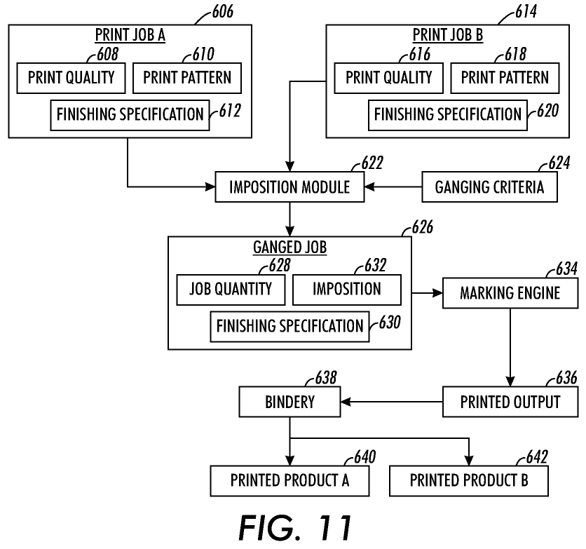

FIG. 11 illustrates a high level block diagram of another system that can aggregate or gang print jobs into a single imposition and use that imposition to produce printed product in accordance with aspects of the disclosed embodiments. Print job A 606 has a print quantity 608, print pattern 610, and finishing specification 612. Print job B 614 also has a print quantity 616 print pattern 618 and finishing specification 620. A print quantity is how many printed pages are desired. A print pattern is what should actually appear on each printed page. A finishing specification specifies, among other things, the material upon which prints are to be marked and page size.

An imposition module 622 obtains print jobs and ganging or aggregation criteria 624 and uses them to produce a ganged job 626. The ganged job 626 is similar to a print job in that it has a job quantity 628 and finishing specification 630. Instead of a print pattern, the ganged job 626 has an imposition 632. In reality, the imposition is a print pattern. The difference is that the imposition is the pattern printed onto a sheet that can have many print positions while a print pattern is the pattern to be printed at a single print position. The marking engine 634 accepts the ganged job 626 to produce printed output 636.

The printed output 636 may be a stack of identically printed sheets, with each sheet being printed with the imposition. A bindery 638 may accept the printed output 636 and produces printed product A 640 and printed product B 642. For example, the printed output can be 1,000 sheets of U.S. currency with 32 bills per sheet. The printed product could include 32,000 bills. Note that U.S. currency is printed with an additional step of adding a unique serial number to each bill.

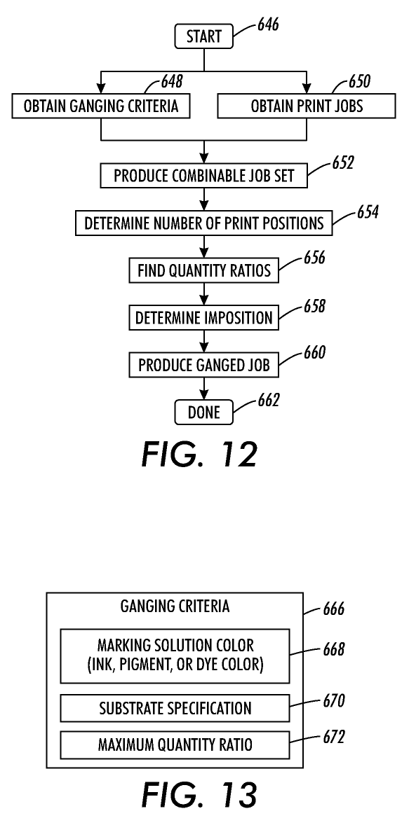

FIG. 12 illustrates a high level flow diagram of producing a ganged job in accordance with aspects of certain embodiments. After the start at 646, ganging criteria are obtained at 648 and print jobs are obtained at 650. A combinable job set 652 is produced by applying the ganging criteria to the print jobs. The number of print positions is determined 654 based on the size of the imposition and the page size of the print jobs. In most cases, standard page sizes are used and the number of print positions and their location in an imposition is known in advance. The quantity ratios are found 656 and used to determine the imposition 658. A ganged job is produced 660 using the determined imposition and the jobs in the combinable job set. Finally, the process is done 662.

FIG. 13 illustrates ganging criteria 666 in accordance with aspects of the disclosed embodiments. Marking solution color 668 can be a ganging criterion. As discussed above, inks, pigments, and dyes are marking solutions. Another ganging criterion can be the substrate specification 670 which specifies the type of paper or other material that is to be printed onto. Also as discussed above, the maximum quantity ratio 672 can be a ganging criterion.

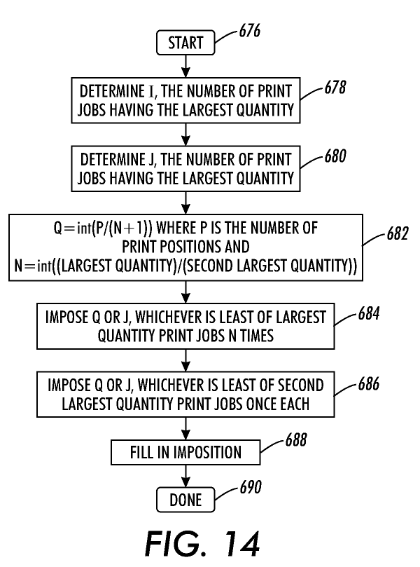

FIG. 14 illustrates a high level flow diagram of using quantity ratios to produce an imposition in accordance with aspects of certain embodiments. After the start 676, the number of jobs having the largest quantity is determined and denoted with the variable “I” 678. Next, the number of jobs having the second largest quantity is determined and denoted with the variable “J” 680. The value of Q is the ratio of P to N+1 rounded down 682. P is the number of print positions in an imposition. N is the quantity ratio between the largest quantity and the second largest quantity rounded down. Consider an example with three print jobs having a print quantity of 300 and two print jobs having a print quantity of 100. Then I=3, J=2, N=300/100=3. If P=12, then Q=12/4=3.

Next, Q of the largest quantity jobs are added to the imposition N times unless Q is greater than 1 in which case only I of the largest quantity jobs are added 684. Returning to the example, Q=3 and I=3 so three of the 300 print quantity jobs are added to the imposition N, with N=3, times. Print positions 1-3 can be set to the first 300 print quantity job. Print positions 4-6 can be set to the second 300 print quantity job. Print positions 7-9 can be set to the third 300 print quantity job.

Q of the second largest quantity jobs are added to the imposition one time unless Q is greater than J in which case only J of the largest quantity jobs are added 406. Returning to the example, Q=3 and J=2 so two of the 100 print quantity jobs are added to the imposition. Print position 10 can be set to the first 100 print quantity job and print position 11 can be set to the second 100 print quantity job. Print position 12 is not yet filled in. As such, another print job can be used to fill in the imposition 688 before the process is done 690. Printing the imposition 100 times and then cutting the sheets into 12 pages results in printed product for all of the print jobs.

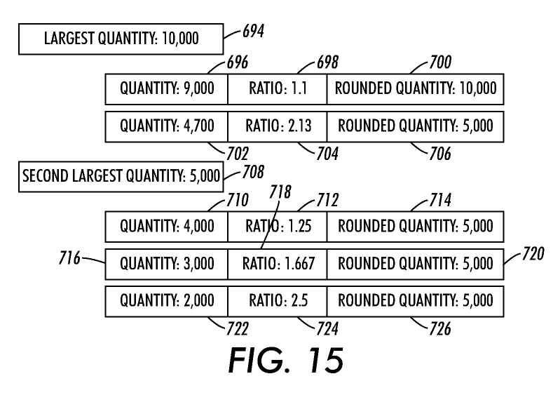

FIG. 15 illustrates a rounding process in accordance with aspects of certain embodiments. In general, the process causes quantity ratios to become integers by increasing print quantities. The largest quantity is 10,000 694. The next largest quantity is 9,000 696 resulting a quantity ratio of 1.1 698. The quantity should be increased to cause the quantity ratio to be 1. As such, the rounded quantity is 10,000 700. The quantity 9,000 has been rounded to the largest quantity.

The next largest quantity is 4,700 702 having a quantity ratio of 2.13 704. A rounded quantity of 5,000 706 results in a quantity ratio of 2. The quantity 4,700 has been rounded to the largest quantity. A quantity ratio greater than 2 indicates that the second largest quantity has been found and rounding to the largest quantity should be stopped. The jobs can be rounded to the second largest quantity. Here, the second largest quantity is 5,000 708 and rounding to the second largest quantity means quantity ratios are calculated based on the second largest quantity.

The next largest quantity is 4,000 710 with a quantity ratio of 1.25 712 resulting in a rounded quantity of 5,000 714. The quantity of 3,000 716 with a quantity ratio of 1.667 718 results in a rounded quantity of 5,000 720. The quantity of 2,000 722 with a quantity ratio of 2.5 724 also results in a rounded quantity of 5,000 726.

Further description regarding the above imposition system (described relative to FIGS. 11-15) can be obtained by reference to U.S. Patent Application Publication 2007/______ A1, published on ______, 2007 (corresponding with U.S. patent application Ser. No. 11/364,258 to Morales et al, filed on Feb. 28, 2006), the pertinent portions or which are incorporated herein by reference.

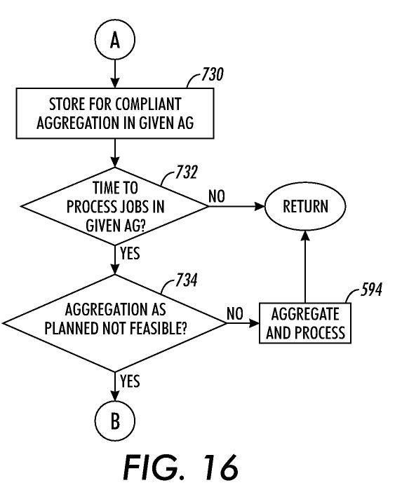

Referring now to FIGS. 9 and 16, the above-described process of forming an alternative aggregation group may be applied to one of the existing AGs in FIG. 6 when a given aggregation condition cannot be met. For instance, in the exemplary embodiment of FIG. 16, jobs compliant with an existing AC may be stored, at 730, for processing at a selected time. When a time for processing arrives (positive answer to query of 732), however, it might be unfeasible to perform aggregation as planned. For instance, as discussed in further detail below, it might be that the stored jobs do not include enough pages to create a suitable aggregated set or production unit. Referring to 734, if aggregation is suitable, then aggregation and processing, as described above is performed (via 594—see FIG. 9); otherwise, the process is directed to 583 of FIG. 9 where formation of an alternate aggregation set or alternate production unit is attempted.

The following examples serve as a supplement to the above descriptions. In some cases, a given production unit will require a certain number of PDLs (corresponding with print jobs) in order to print properly. In these cases, the system might have multiple production unit creation rules based on whether the ideal production unit can be created or not. For example:
1. In one example of operation, the system manager 548 of FIG. 6 (referred to simply as “system” below) might be gathering 4×6 postcards in order to create production units for similar quantities that will be printed 9-up on 12×18 paper. If some of the postcards reach a certain age, the system might decide, as in the example of FIG. 16 that it is time to look at alternate production plans.
2. Accordingly, the system may gather the oldest postcards, along with two postcard types having the same print quantity, and combine all the postcards into a production unit for 3-up imposition (using dutch imposition) on 8.5×11 print media.
3. If the system cannot find three postcard types with the same print quantity, it might look for postcards whose print quantity is double or half of the print quantity of the oldest postcards. Understanding that the production unit is intended to be imposed 9-Up on 11×17 and printed using the lowest print quantity from the group, the system gathers enough postcards to fill the 9 position on the imposed layout (e.g., the original postcard (100 copies), two postcards that also need 100 copies and 3 postcards that need 200 copies). Once these postcards are selected, they are combined using an approach of “proportional concatenation” (as described above with respect to FIGS. 11-15).
4. If the system does not find the right postcards in the correct quantities, the system might attempt to fill the smaller 3-Up layout using proportional concatenation.
5. If the system cannot create a production unit with similar jobs, the system might choose to fill the simpler layout with jobs of slightly different dimensions. For example, the 3-Up layout has room for an additional 0.5 inch horizontally and 1 inch vertically. An example of a layout using documents of differing dimensions is shown in FIG. 10C.
6. If the system still cannot create a production unit, the system can forego creating a production unit and instead release one or more jobs into production without creating a production unit

Based on the above description, the following features should now appear:
A first print job set, with each job of the first print job set complying with print job aggregation criteria, may be stored until a first selected condition is met. A second print job set, in which each job does not comply with a print job aggregation criteria, may be stored until a second selected condition is met. When the second selected condition is met, a determination as to whether the print jobs of the second print job set are aggregatable is made. To facilitate such determination, selected information about each one of the print jobs of the second print jobs set may be collected. When it is determined that the print jobs of the second print job set are aggregatable, the print jobs of the second print job set may be aggregated in accordance with one of a plurality of aggregation modes. In one example the plurality of aggregation modes may be prioritized into a hierarchy and the hierarchy used to determine in which of the plurality of aggregation modes the print jobs of the second print job set are to be aggregated.
In one example of implementation, one or both of the first and second selected conditions may be corresponded with a page count threshold. In another example of implementation, information regarding the age of at least one print job of the second print job set is maintained and the second selected condition may be met when the age of the at least one print job of the second print job set exceeds a selected threshold.
In one contemplated approach, the second selected condition is met, each print job of the second print job set comprises input pages, and the print jobs of the second print job set are aggregated by imposing reduced input pages on one or more output sheets. In one example, each print job of the second print job set corresponds with a print quantity and the contemplated approach includes (1) determining print quantity ratios for the print jobs of the second print job set, and (2) automatically generating an imposition pattern with the print quantity ratios. In another example, the output sheets comprise a first stack and the contemplated approach includes: imposing the reduced input pages in such a way that when the first output stack is cut vertically into second and third stacks, the second and third stacks can be collated for separation by placing the second stack on top of the third stack. In another example, the contemplated approach includes imposing reduced input pages of different dimensions on each output sheet.

A system and method for performing alternate forms of production-mandated aggregation in order to deal with instances in which the ideally defined production-mandated aggregation cannot be executed has now been described. The above-described system has the capability of not only collecting unrelated jobs and creating a corresponding production unit, when possible, but of creating an alternate aggregation scheme when it becomes apparent that aggregation may not, due to scheduling constraints, be achievable for a given AG.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

What is claimed is:

1. A computer implemented method of automatically aggregating multiple print jobs, comprising:
(A) receiving a print job;
(B) determining, with a system manager, whether the received print job complies with print job aggregation criteria;
(C) if the received print job complies with the print job aggregation criteria, associating the received print job with one or more print jobs of a first print job set, each one of the one or more print jobs of the first print job set complying with the print job aggregation criteria;
(D) if a first selected condition is met, (1) aggregating the print jobs of the first print job set, and (2) causing the aggregated first print job set to be processed with at least one document processing resource;
(E) if the received print job does not comply with the print job aggregation criteria, associating the received print job with one or more print jobs of a second print job set;
(F) if a second selected condition is met, (1) determining if the print jobs of the second print job set are aggregatable, and (2) responsive to (F)(1), either (a) aggregating the print jobs of the second print job set and causing the aggregated second print job set to be processed with at least one document processing resource, or (b) causing a non-aggregated second print job set to be processed with at least one document processing resource.

2. The method of claim 1, further comprising:
(G) obtaining selected information about each one of the print jobs of the second print job set, the selected information being used to perform (F)(1).

3. The method of claim 1, wherein said (F)(2)(a) includes aggregating the print jobs of the second print job set in accordance with one of a plurality of print job aggregation modes.

4. The method of claim 3, further comprising:
(G) prioritizing the plurality of aggregation modes into a hierarchy; and
(H) using said hierarchy to determine in which of the plurality of aggregation modes the print jobs of the second print job set are to be aggregated.

5. The method of claim 1, further comprising corresponding one or both of the first and second selected conditions with a page count threshold.

6. The method of claim 1, in which information regarding the age of at least one print job of the second print job set is maintained, further comprising:
(G) causing the second selected condition to be met when the age of the at least one print job of the second print job set exceeds a selected threshold.

7. The method of claim 1, in which the second selected condition is met and each print job of the second print job set comprises input pages, wherein said (F)(1)(a) includes imposing reduced input pages on one or more output sheets.

8. The method of claim 7, in which each print job of the second print job set corresponds with a print quantity, further comprising:
(G) determining print quantity ratios for the print jobs of the second print job set; and
(H) automatically generating an imposition pattern with the print quantity ratios.

9. The method of claim 7, in which the output sheets comprise a first stack, further comprising:
(G) imposing the reduced input pages in such a way that when the first output stack is cut vertically into second and third stacks, the second and third stacks can be collated for separation by placing the second stack on top of the third stack.

10. The method of claim 7, further comprising:
(G) imposing reduced input pages of different dimensions on each output sheet.

11. A computer implemented method of automatically aggregating multiple print jobs, comprising:
(A) storing a plurality of print jobs in memory, each one of the plurality of print jobs complying with a selected print job aggregation criteria;
(B) aggregating the plurality of print jobs stored in memory in a first print job aggregation mode if a selected condition is met within a selected time interval;
(C) if the selected condition cannot be met within the selected time interval, determining whether the plurality of print jobs can be aggregated in accordance with a second print job aggregation mode;
(D) responsive to said (C) either, (1) aggregating the plurality of jobs in accordance with the second print job aggregation mode and causing the plurality of jobs aggregated in accordance with the second print job aggregation mode to be processed with at least one document processing resource, or (2) causing the plurality of print jobs, in a non-aggregated form, to be processed with at least one document processing resource.

12. The method of claim 11, further comprising:
(E) obtaining selected information about each one of the plurality of print jobs, the selected information being used to perform (D)(1).

13. The method of claim 11, further comprising:
(E) selecting the second print job aggregation mode from one of a plurality of print job aggregation modes.

14. The method of claim 13, further comprising:
(F) prioritizing the plurality of aggregation modes into a hierarchy; and
(G) using said hierarchy to perform said (E).

15. The method of claim 11, further comprising corresponding the selected condition with a page count threshold so that the selected condition is not met unless a selected page count is obtained within the selected time interval.

16. The method of claim 11, in which information regarding the age of at least one print job of the plurality of print jobs is maintained, further comprising:
(E) delaying performance of said (C) and (D) as long as the age of the at least one print job of the plurality of print jobs does not exceed a selected threshold.

17. The method of claim 11, in which the selected condition is not met and each print job of the plurality of print jobs comprises input pages, wherein said (D)(1) includes imposing reduced input pages on one or more output sheets.

18. The method of claim 17, in which each print job of the plurality of print jobs corresponds with a print quantity, further comprising:
(E) determining print quantity ratios for the print jobs of the plurality of print jobs; and
(F) automatically generating an imposition pattern with the print quantity ratios.

19. A computer implemented method of automatically aggregating multiple print jobs, comprising:
(A) storing a first print job set comprising a plurality of first type print jobs in memory, each one of the first type print jobs complying with print job aggregation criteria;
(B) if a first selected condition is met, (1) aggregating the first type print jobs of the first print job set, and (2) causing the aggregated first print job set to be processed with at least one document processing resource;
(C) storing a second print job set comprising a plurality of second type print jobs in memory, each one of the second type print jobs failing to comply with the print job aggregation criteria; and
(D) if a second selected condition is met, (1) determining if the second type print jobs of the second print job set are aggregatable, and (2) responsive to (D)(1), either (a) aggregating the second type print jobs of the second print job set and causing the aggregated second print job set to be processed with at least one document processing resource, or (b) causing a non-aggregated second print job set to be processed with at least one document processing resource.

20. The method of claim 19, further comprising:
(E) obtaining selected information about each one of the plurality of second type print jobs, the selected information being used to perform (D)(1).

21. The method of claim 19, further comprising:
(E) selecting the second print job aggregation mode from one of a plurality of print job aggregation modes.

22. The method of claim 21, further comprising:
(F) prioritizing the plurality of aggregation modes into a hierarchy; and
(G) using said hierarchy to perform said (E).

23. The method of claim 19, in which the second selected condition is met and each print job of the plurality of second type print jobs comprises input pages, wherein said (D)(1) includes imposing reduced input pages on one or more output sheets.

24. A system for automatically aggregating multiple print jobs, comprising:
a system manager for controlling a flow of print jobs in the system; and
a computer-readable storage medium comprising one or more programming instructions that, when executed, instruct the system manager to:
determine whether a received print job complies with print job aggregation criteria,
if the received print job complies with the print job aggregation criteria, associate the received print job with one or more other print jobs complying with the print job aggregation criteria, the one or more print jobs complying with the print job criteria comprising a first print job set,
if a first selected condition is met, (1) aggregate the print jobs of the first print job set, and (2) cause the aggregated first print job set to be processed with at least one document processing resource,
if the received print job does not comply with the print job aggregation criteria, associating the received print job with one or more print jobs of a second print job set;
if a second selected condition is met, (1) determine if the print jobs of the second print job set are aggregatable, and (2) responsive to determining if the print jobs of the second print job set are aggregatable either (a) aggregate the print jobs of the second print job set and cause the aggregated second print job set to be processed with at least one document processing resource, or (b) cause a non-aggregated second print job set to be processed with at least one document processing resource.

25. The system of claim 24, in which the second selected condition is met, wherein the determination as to whether the print jobs of the second print job set are aggregatable is made with selected information about each one of the print jobs of the second print job set.

26. The system of claim 24, in which the second selected condition is met and it is determined that the print jobs of the second print job set are aggregatable, wherein the print jobs of the second print job set are aggregated in accordance with one of a plurality of print job aggregation modes.

27. The system of claim 26, wherein the plurality of print job aggregation modes are prioritized into a hierarchy and said hierarchy is used to select in which of the plurality of print job aggregation modes the print jobs of the second print job set will be aggregated.
